(19) United States
(12) Patent Application Publication
(10) Pub. No.: US 2026/0282074 A1
(43) Pub. Date: Sep. 17, 2026

(54) RF ENERGY HARVESTING IN COMMUNICATION SYSTEMS

(71) Applicant: Nokia Solutions and Networks Oy, Espoo (FI)

(72) Inventors: Markus Warken, Laupheim (DE); Martin Goldberg, Eching (DE)

(21) Appl. No.: 19/152,490

(22) PCT Filed: Jan. 31, 2023
(86) PCT No.: PCT/EP2023/052237

§ 371 Date: Jul. 31, 2025

(51) Int. Cl. H04W 74/00; H04W 4/80; H04W 72/044

(52) U.S. Cl. CPC H04W 74/004; H04W 4/80; H04W 72/044

(57) ABSTRACT

The present subject matter relates to a method including: receiving at an apparatus radio frequency signals via an antenna of the apparatus; converting energy in the received radio frequency signals into electric energy; storing the electric energy in an energy storage device; and using the stored energy for transmitting an access request signal in accordance with uplink time-frequency resources of the communication system which are assigned to the apparatus.

### TECHNICAL FIELD

Various example embodiments relate to telecommunication systems, and more particularly to radio frequency (RF) energy harvesting.

### BACKGROUND

The radio-frequency identification (RFID) stands for a technology of sender-receiver systems for automated contact-less identification and localization of objects using electromagnetic radiation. An RFID system may consist of a transponder (“tag”) attached to an object and containing some identification code and a reader to retrieve this code. Coupling of transponder and reader may be achieved through electromagnetic fields emitted by the reader. This way, data may be transmitted and the passive transponder is supplied with energy. Distances between reader and passive transponders may typically be few centimetres. To bridge larger distances up to 100 meters (m), active transponders with own power supply may be used. However, there may be a need for alternative improved solutions.

### SUMMARY

Example embodiments provide an apparatus for a communication system, the apparatus comprising means. The means are configured for: receiving radio frequency signals; converting energy in the received radio frequency signals into electric energy; storing the electric energy; using the stored energy for transmitting an access request signal in accordance with uplink time-frequency resources of the communication system which are assigned to the apparatus. The communication system may, for example, be a wireless communication system.

Example embodiments provide a method comprising: receiving at an apparatus radio frequency signals via an antenna of the apparatus; converting energy in the received radio frequency signals into electric energy; storing the electric energy in an energy storage device; using the stored energy for transmitting an access request signal in accordance with uplink time-frequency resources of a communication system which are assigned to the apparatus.

Example embodiments provide a computer program comprising instructions for causing an apparatus for: receiving radio frequency signals; converting energy in the received radio frequency signals into electric energy; storing the electric energy; using the stored energy for transmitting an access request signal in accordance with uplink time-frequency resources of a communication system which are assigned to the apparatus.

Example embodiments provide a communication system comprising: means for receiving radio frequency signals; means for converting energy in the received radio frequency signals into electric energy; means for storing the electric energy; means for using the stored energy for transmitting an access request signal in accordance with uplink time-frequency resources of the communication system; means for receiving the access request signal; means for determining distances to the means of transmission using the received access request signals; and means for determining a position of the means of transmission using the distances.

Example embodiments provide a method comprising: receiving by an apparatus radio frequency signals; converting by the apparatus energy in the received radio frequency signals into electric energy; storing by the apparatus the electric energy; using the stored energy for transmitting by the apparatus an access request signal in accordance with uplink time-frequency resources of the communication system which are assigned to the apparatus; receiving the access request signal by nodes; determining by the nodes distances between the nodes and the apparatus using the respective received access request signals; and using the distances for determining a position of the apparatus.

Example embodiments provide a computer program comprising instructions for causing a system for: receiving radio frequency signals; converting energy in the received radio frequency signals into electric energy; storing the electric energy; using the stored energy for transmitting by an apparatus an access request signal in accordance with uplink time-frequency resources of the communication system which are assigned to the apparatus; receiving the access request signal; determining distances to the apparatus using the received access request signals; and using the distances for determining a position of the apparatus.

### BRIEF DESCRIPTION OF THE DRAWINGS

The accompanying figures are included to provide a further understanding of examples, and are incorporated in and constitute part of this specification. In the figures:

FIG. 1 illustrates a part of an exemplifying radio access network;

FIG. 2 is a schematic illustration of a wireless communication system;

FIG. 3 is a flowchart of a method according to an example of the present subject matter;

FIG. 4 is a flowchart of a method according to an example of the present subject matter;

FIG. 5 illustrates an example of messages exchanged between an apparatus and base stations in accordance with an example of the present subject matter;

FIG. 6A is a diagram illustrating a method for sending a PRACH burst by a tag to a base station in accordance with an example of the present subject matter;

FIG. 6B is a diagram illustrating a method for sending a PRACH burst by a tag to a base station in accordance with an example of the present subject matter;

FIG. 7 is a block diagram showing an example of an apparatus according to an example of the present subject matter.

### DETAILED DESCRIPTION

In the following description, for purposes of explanation and not limitation, specific details are set forth such as particular architectures, interfaces, techniques, etc., in order to provide a thorough understanding of the examples. However, it will be apparent to those skilled in the art that the disclosed subject matter may be practiced in other illustrative examples that depart from these specific details. In some instances, detailed descriptions of well-known devices and/or methods are omitted so as not to obscure the description with unnecessary detail.

A communication system may be provided. The communication system comprises nodes such as base stations, wherein each node may serve user equipments (UEs) located within the node's geographical area of service or a cell. The communication system may support one or more Radio Access Technologies (RATs). The Radio Access Technology may, for example, be evolved universal terrestrial radio access (E-UTRA) or 5G new radio (NR), but it is not limited to, as a person skilled in the art may apply the present subject matter to other communication systems provided with necessary properties.

The present subject matter may make use of the communication system to operate systems which require little power without relying on an ad-hoc recharging of these systems. In particular, these systems may, for example, be powered wirelessly using energy provided by the communication system. This may be advantageous because a high number of systems such as sensors and edge-devices may be operated using the communication system. The communication system may also enable a flexible deployment of these systems. These systems might be deployed in places that are hard to reach and/or are very remotely located.

An apparatus may be provided. The apparatus may, for example, be a user equipment, a sensor, or a device capable for harvesting energy. The apparatus may, for example, be a power-less supply apparatus as it may not need a power supply. The apparatus may comprise means configured to receive radio frequency signals. The radio frequency signals may propagate wirelessly. The radio frequency signals may originate from a radio frequency transmitter that is at a distance away from the apparatus. The means may, for example, comprise an antenna via which the radio frequency signals may be received at the apparatus. The access request signal may be transmitted via said antenna or via another antenna of the apparatus. The antenna may, for example, be operated according to a parity-time (PT) symmetry. The PT symmetry may, for example, be achieved by adding a nonlinear saturable gain element to the antenna. Using the PT symmetry may overcome the need of synchronization to the resonance frequency, allowing fast mobility and flexible positioning of the apparatus. This may enable a robust system for harvesting energy.

The means of the apparatus may be configured to convert energy in the received radio frequency signals into direct current electrical energy. For example, the means may comprise an energy harvesting unit. The energy harvesting unit may be configured to perform the conversion of the energy in the received radio frequency signals into the direct current electrical energy. This may enable to harvest energy. In one example, the energy harvesting unit may comprise a rectifier. The antenna may serve as a transducer to convert the strength of an electric field into a voltage difference, or vice versa, wherein the rectifier may convert the radio frequency power to direct current power.

The harvested energy may, for example, be energy of some electromagnetic radiation field. The harvested energy may be ambient radio frequency energy and/or an intended radio frequency energy. The intended radio frequency energy may be provided by one or more specific radio frequency transmitters (e.g., nodes) that emit signals directly to specific areas. The intended radio frequency energy may be advantageous as it may be collected in defined frequency bands. The ambient radio frequency energy may be advantageous as it may be accessible over a broad range of frequency bands.

The harvested energy may be stored for future use by the apparatus. The energy may, for example, be stored in an energy storage device of the apparatus. The energy storage device may comprise one or more capacitors and/or a battery.

The apparatus may be assigned uplink time-frequency resources. The uplink time-frequency resources may be used by the apparatus for carrying information. These resources may be termed physical channels. The physical channels may be specified for uplink transmission of data. For example, the available time and frequency resources, in the communication system, may be used in accordance with a multi-user configuration by dividing them into parts and sharing the parts amongst many devices including the apparatus. The multi-user configuration may need a time and frequency synchronization between the devices.

The apparatus may thus make use of energy harvesting and resources of an existing communication system in order to transmit signals. For example, the means of the apparatus may be configured to use the stored energy for transmitting an access request signal in accordance with uplink time-frequency resources of the communication system which are assigned to the apparatus. For example, while the apparatus is being powered by the stored energy, the means of the apparatus transmits the access request signal in accordance with uplink time-frequency resources of the communication system which are assigned to the apparatus.

The present subject matter may thus use the whole communication system as an RFID-reader. The communication system may comprise one or more Public Land Mobile Networks (PLMNs). The present subject matter may be advantageous as it may satisfy the requirement of a low maintenance of transporters and may support large distances between the apparatus and a reader. The present subject may solve the problem of tracking or locating energy-supply less devices over long distances, due to the world-wide coverage of PLMNs in principle limitless. The present subject matter may enable an RFID system based on mobile networks overcoming the problem of energy supply of a passive RFID transponder through energy harvesting while allowing up to cell-size transponder-reader distances. In addition, it may provide high mobility using the whole PLMN as RFID-reader.

In one example, the means of the apparatus are configured to receive via the antenna the radio frequency signals in a set of one or more frequency bands, wherein the access request signal is transmitted in a selected frequency band of the one or more frequency bands. For example, the apparatus may harvest energy from radio frequency signals which are obtained in a subset of said set of frequency bands. The selected frequency band may be any frequency band (e.g., a randomly selected frequency band) of the subset of frequency bands. This may save resources as a random selection may be easily implemented and may be faster compared to a condition-based selection. Alternatively, the selected frequency band may be the frequency band of the subset of frequency bands that has been lastly used to acquire the radio frequency signals. Selecting the lastly used harvesting frequency band may increase the reception efficiency of the access request signal at a receiver transmitting in that selected frequency band, because of the high probability that the current position of the apparatus and the receiver's position are e.g., in a same cell.

The antenna may, for example, be a single-band antenna, which is configured to operate in a single frequency band. This may enable to harvest in one dedicated band only (frequency selective). This may ensure that the apparatus transmits the positioning signal only in areas, where this frequency band is used. Alternatively, the antenna of the apparatus may be a wideband antenna. The wideband antenna may be configured to harvest energy from various sources over a wide frequency range. This may enable to collect more energy. Alternatively, the antenna of the apparatus may be a multi-band antenna. The multiband antenna may be configured to harvest energy from various sources on multiple frequency bands. In case energy is harvested in multiple frequency bands, the apparatus may transmit the access request signal only on the frequency where energy was harvested.

In one example, the apparatus may be configured to transmit the access request signal on a frequency band different from said set of one or more frequency bands. This may enable to use different antennas for transmission and energy harvesting. This may enable a flexible implementation of the present subject matter.

In one example, the means of the apparatus are configured for repeatedly transmitting the access request signal in accordance with a transmission frequency. This may enable a systematic and predictable transmission of signals. This may improve the reception efficiency of these signals. In another example, the repeated transmission of the access request signal may be performed in predefined transmission times. This may enable a flexible implementation of the signal transmission. The transmission times may, for example, be defined using a timer implemented in a control logic of the apparatus. The timer may be configured to automatically switch “on” a transceiver circuit for a specific period of time in order to transmit the access request signal.

In one example, the transmission frequency is a pre-configured parameter whose value is received from a node of the communication system. This may enable a centrally controlled transmission of the access request signals. This may particularly be advantageous as the communication system may comprise a high number of apparatuses such as the present apparatus.

In one example, the means of the apparatus are configured for estimating the transmission frequency using a rate of collection of energy by the apparatus. This may enable an accurate definition of the transmission frequency that can be dynamically adapted based on current energy collection rates.

The apparatus may be configured to harvest and thus collect the energy according to an energy collection rate. The energy collection rate may, for example, depend on the distance between the apparatus and the radio frequency transmitter that provides the radio frequency waves. In one example, the energy collection rate may be measured using the apparatus. Alternatively, the energy collection rate may be estimated. For example, given an radio frequency energy source k in a free-space channel

$${P}_{H}^{k} ,$$

the energy collection rate may be defined based on the Friis equation as follows:

$${P}_{H}^{k} = ϱβ {P}_{S} \frac{{G}_{S} {G}_{H} {λ}^{2}}{{( 4 π {d}_{k} )}^{2}} ,$$

where β is the RF-to-DC power conversion efficiency of the apparatus app, and [symbol] is an efficiency factor which depends on the specific architecture. For a given RF energy source, P_{S} is its transmit power, G_{S} is its transmit antenna gain, λ is the wavelength at which it emits, dₖ is the distance of the RF energy source k to the receiver antenna of the apparatus and G_{H} is the receive antenna gain of the apparatus.

In case of a set of multiple RF sources, the energy collection rate may be an aggregated energy collection rate that may be obtained as follows:

$${P}_{H} = {Σ}_{k ∈ 𝒦} {P}_{H}^{k} ,$$

where [symbol] is the set of RF energy sources.

In one example, the means of the apparatus are configured to transmit the access request signal according to a Radio Resource Control, RRC, protocol. The RRC protocol may, for example, be provided by a 3GPP protocol as defined for 5G NR. In one example, the access request signal is a random access signal on a physical random access channel, PRACH. The access request signal may, for example, be a PRACH burst. This may enable a seamless integration of the present subject matter with existing access protocols. In addition, the apparatus may be configured to work only with this PRACH functionality. This may be advantageous because a simple chip, antenna and capacitor may be sufficient to implement the PRACH functionality. In another example, the access request signal may be a positioning reference signal (PRS).

In one example, the access request signal comprises information that is configured to trigger a determination of the position of the apparatus based on the access request signal. One or more nodes of the communication system may receive the access request signal. For example, at least three nodes of the communication system may receive the access request signal. The nodes may determine the timing advance, e.g., the signal runtime from the apparatus to the node, and by this the distance between the apparatus and antenna of the node. Via triangulation using these distances, the position of the apparatus may be estimated with a precision error in a range between 10 cm-10 m depending on the node distances.

The position may advantageously be used depending on use cases. The apparatus according to the present subject matter may, for example, be used for container tracking. For example, the apparatus may be used on a container as an active label that has no power consumption at all while the container ship is at sea but get activated when the ship enters the harbour. This may enable material and storage management over long distances at low cost and logistics. In another example, the apparatus may be used for the identification and supervision of persons, animals or objects, real-time verification of documents, theft-prevention, fraud-prevention, access control, active sensors, payment systems and process automation over large distances.

In one example, the access request signal comprises a unique identifier of the apparatus. The identifier may, for example, be a PLMN RFID unique identifier (PRUID), that may be assigned by the PLMN to which the apparatus is connected. The identifier may be an integer with sufficiently large number space like 128 bits. The communication system may be configured to support this functionality to combine PRACH access technique including such a unique identifier.

The PRACH burst may, for example, have a positioning burst identifier (PBI). The PBI may be realized by coding extra bits in the PRACH message. This PBI may be used to determine that this is a positioning burst, and may allow a precise correlation of this burst in time.

In one example, the uplink time-frequency resources are preconfigured resources. This may save network resources compared to having these resources dynamically adapted. These fixed resources may advantageously be used to deploy stationary apparatuses with fixed locations.

In one example, the means of the apparatus are configured to use the stored energy to receive and decode a configuration signal from a node of the communication system. The configuration signal indicates the uplink time-frequency resources. This may enable a centrally and dynamically controlled scheduling of resources in the communication system. This may enable an optimized use of resources of the communication system.

In one example, the means of the apparatus are configured to use the stored energy in response to determining that the stored energy is higher than the energy required to perform the transmission of the access request signal. In one example, a monitoring circuit may be used to monitor the level of energy stored in the energy storage device. For example, the monitoring circuit may comprise a Zener diode.

In one example, the means of the apparatus are configured to use the stored energy to sense one or more physical characteristics of an environment of the apparatus, wherein the access request signal comprises the sensed values. The physical characteristic may, for example, be temperature, pressure or any characteristic whose value can be sensed and can be transmitted in the access control signal. Following the above example, further information such as the temperature in the interior of a container could be transported additionally in the PRACH bursts to support richer functionality beyond pure positioning.

In one example, the apparatus is comprised in a mobile device, wherein the means are configured to transmit the access request signal in case the mobile device is switched off or out of battery. The mobile device being out of battery may mean that its battery is empty. For example, the present method may be used for the location or tracking of persons with switched-off mobiles, e.g., when hiking without ability to re-charge the battery of the mobile. This may allow the localisation in sufficiently short intervals ensuring fast rescue action in case it becomes necessary. For example, the apparatus app may be provided as an integral part of the mobile device, wherein the existing antenna of the mobile device may be used by the apparatus to harvest energy and/or transmit the access request signal.

In one example, the apparatus may comprise a portable medical device. The portable medical device may be used to track patients' physiological conditions in post-acute, rehabilitation, and chronic cases. The portable medical device may, for example, be a measuring device for determining the insulin level for a patient and for triggering an alarm if the insulin value exceeds a threshold. For example, persons having the measuring device and are no longer able to get help themselves (e.g., due to sugar coma) may be reached according to the present subject matter. In particular, the access request signal sent by the medical device may enable to locate the position of the person.

In one example, the means of the apparatus are configured to use a same or different antenna to receive the radio frequency signals and to transmit the access request signal. This may enable a flexible implementation of the present subject matter. In addition, this may enable to harvest energy in parallel to transmitting the access request signal.

The communication system may provide telecommunication services to user equipment through one or more communication networks. The communication network may, for example, be a PLMN. The PLMN may logically be divided into a radio access network (RAN) and a core network (CN), connected via an open interface. The core network may, for example, comprise an Access and Mobility Management function (AMF), a Policy Control Function (PCF) or a Mobility Management Entity (MME). The radio access network may comprise one or more base stations. The PLMN has a geographical area in which the base stations provide voice and data services to user equipment. The base station of the PLMN may serve user equipment located within the base station's geographical area of service or a cell. For example, the base station of the PLMN may serve user equipment that have selected said PLMN. The PLMNs may be provided by a plurality of network operators (PLMN operators). The apparatus may, for example, be served by a selected PLMN of the communication system. The apparatus may, for example, have a subscription with the communication system e.g., the apparatus may comprise a valid universal subscriber identity module (USIM) containing the credentials of a subscription with the communication system.

The present subject matter may comprise the following examples.

Example 1: An apparatus comprising: at least one processor; an antenna; a rectifier; an RF transceiver for communicating on a communication network accessible to the apparatus; and at least one memory storing instructions that, when executed by the at least one processor, cause the apparatus at least to perform: receiving radio frequency signals via the antenna; converting by the rectifier energy in the received radio frequency signals into electric energy; storing the electric energy; using the stored energy for transmitting by the RF transceiver an access request signal in accordance with uplink time-frequency resources of the communication system which are assigned to the apparatus.

The RF transceiver may, for example, comprise a radio transmitter. The radio transmitter may be configured to supply an oscillating radio frequency electric current to the antenna, and the antenna may radiate the energy from the current as electromagnetic waves (e.g., radio waves).

Example 2: A non-transitory computer readable medium comprising program instructions that, when executed by an apparatus, cause the apparatus to perform at least the following: receiving radio frequency signals; converting energy in the received radio frequency signals into direct current energy; storing the direct current energy; using the stored energy for transmitting an access request signal in accordance with uplink time-frequency resources of the communication system which are assigned to the apparatus.

Example 3: A communication system comprising at least one processor and at least one memory storing instructions that, when executed by the at least one processor, cause the communication system at least to perform: receiving radio frequency signals; converting energy in the received radio frequency signals into electric energy; storing the electric energy; using the stored energy for transmitting by an apparatus an access request signal in accordance with uplink time-frequency resources of the communication system which are assigned to the apparatus; receiving the access request signal; determining distances to the apparatus using the received access request signal; and using the distances for determining a position of the apparatus.

Example 4: A non-transitory computer readable medium comprising program instructions that, when executed by a system, cause the system to perform at least the following: receiving radio frequency signals; converting energy in the received radio frequency signals into electric energy; storing the electric energy; using the stored energy for transmitting by an apparatus an access request signal in accordance with uplink time-frequency resources of the communication system which are assigned to the apparatus; receiving the access request signal; determining distances to the apparatus using the received access request signal; and using the distances for determining a position of the apparatus.

Example 5: A communication system comprising an apparatus, nodes and a core network element, wherein the apparatus comprises at least one processor; an antenna; a rectifier; an RF transceiver; and at least one memory storing instructions that, when executed by the at least one processor, cause the apparatus at least to perform: receiving radio frequency signals via the antenna; converting by the rectifier energy in the received radio frequency signals into electric energy; storing the electric energy; using the stored energy for transmitting by the RF transceiver an access request signal in accordance with uplink time-frequency resources of the communication system which are assigned (e.g., by the communication system) to the apparatus; wherein each node of the nodes is configured to receive the access request signal; determine a distance between the node and the apparatus using the access request signal and send the access request signal to the core network element of the communication system, wherein the core network element is configured for determining the position of the apparatus using the received distances.

Example 6: A computer program comprising multiple program parts, each program part having a subset of instructions of the computer program. The execution of the computer program comprises the execution of the program parts by respective components of a communication system. The execution of the program parts by respective components of the system cause the components to perform respective subset of steps of a set of steps, wherein the set of steps comprise: receiving radio frequency signals; converting energy in the received radio frequency signals into electric energy; store the electric energy; using the stored energy for transmitting by an apparatus an access request signal in accordance with uplink time-frequency resources of the communication system which are assigned to the apparatus; receiving the access request signal; determining distances to the apparatus using the received access request signals; and using the distances for determining a position of the apparatus.

For example, RF waves may be received through an antenna of the apparatus. This may cause a potential difference across the length of the antenna. This potential difference may cause charge carriers to move along the length of the antenna. The energy from this movement may be converted by the apparatus into a stable DC current which is then stored in the apparatus or used to power electronic devices that consume the harvested energy. The electronic devices may, for example, be chips, circuits, actuators, sensors, etc.

The present subject matter may thus have the following advantages.
As PLMNs may cover the whole surface of the planet, typically via several supported frequency bands in parallel, the present apparatus may be provided as a 5G-capable RFID transponder which may solve any issue with distance between transponder and reader. A sending power of 250 mW may be sufficient to bridge the distance between any location in a macro cell to the base station (BTS).
The present apparatus may make use of radiation energy already available within the PLMN otherwise unused/wasted. The apparatus may be provided as a tag and a PT-lock may overcome the need of synchronization to the resonance frequency of the receiver in the tag to a large extent, allowing fast mobility and flexible positioning of the tag.
The present subject matter may combine the advantages of passive RFID tags—cheap—with those of active RFID tags—large range—without the need for a power supply as this is covered by harvesting available otherwise waste energy of the PLMN. This way, the present subject matter may address the multi-billion market for battery-less devices.
Tracking and positioning of material, containers, devices can be only handled by RFID style approach with large distance/coverage.
The PLMN could support all functions of existing RFID systems, now areawide or even world-wide. Examples are a. material and storage management over long distances at low cost, b. logistic applications like container management or c. the supervision of commodity flows or theft protection e.g., of car parks—any attempt to move the car without key would result in an alarm to the nearest police office.
The PLMN operator may define the frequency layer to be used for and/or schedule PRACH bursts of the RF-ID tags while the latter can use all existing frequency layers simultaneously for energy harvesting.
The present subject matter may support a further logic allowing to collect high-precision positioning relevant data and send not only PRACH bursts but standardized positioning reference signals, PRS, for e.g., assisted global positioning system (A-GPS) or within a terrestrial beacon system.
High precision positioning systems based on GNSS or TBS provide timing information with the same quality as position data. Hence, the present subject matter may allow to support both, high precision positioning and synchronization.
Further information like, e.g., temperature in the interior of a container, may be transported additionally in the PRACH bursts to support richer functionality beyond pure positioning.

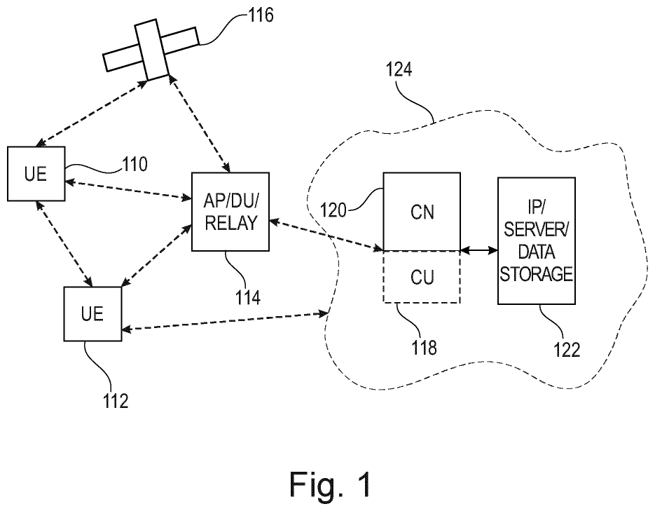

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows devices 110 and 112. The devices 110 and 112 may, for example, be user devices. The devices 110 and 112 are configured to be in a wireless connection on one or more communication channels with a node 114. The node 114 is further connected to a core network 120. In one example, the node 114 may be an access node (such as (e/g)NodeB) 114 providing or serving devices in a cell. In one example, the node 114 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 20 (CN or next generation core NGC). For example, the (e/g)NodeB may connect to an access and mobility management function (AMF) and user plane function (UPF) in the control plane and user plane, respectively. Depending on the system, the counterpart on the CN side can be a serving gateway (S-GW, routing and forwarding user data packets), packet data network gateway (P-GW), for providing connectivity of devices (UEs) to external packet data networks, or mobile management entity (MME), etc.

The device (also called user device, UE, user equipment, user terminal, terminal device, etc.) illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station.

The device typically refers to a device (e.g. a portable or non-portable computing device) that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilize cloud. In some applications, a device may comprise a user portable device with radio parts (such as a watch, earphones or eyeglasses) and the computation is carried out in the cloud. The device (or in some embodiments a layer 3 relay node) is configured to perform one or more of user equipment functionalities. The device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented. 5G enables using multiple input-multiple output (MIMO) antennas, many more base stations or nodes than an existing LTE system (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHZ, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G may support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet as illustrated by the component referenced by reference numeral 122, or utilize services provided by them. The communication network may also be able to support the usage of cloud services, for example at least part of core network operations may be carried out as a cloud service (this is depicted in FIG. 1 by “cloud” 124). The communication system may also comprise a central control entity, or a like, providing facilities for networks of different operators to cooperate for example in spectrum sharing.

The technology of Edge cloud may be brought into a radio access network (RAN) by utilizing network function virtualization (NVF) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 114) and non-real time functions being carried out in a centralized manner (in a centralized unit, CU 118).

It should also be understood that the distribution of labour between core network operations and base station operations may differ from that of the LTE or even be non-existent. Some other technology advancements probably to be used are Big Data and all-IP, which may change the way networks are being constructed and managed. 5G is being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite 116 in the mega-constellation may cover several satellite-enabled network entities that create on-ground cells. The on-ground cells may be created via an on-ground relay node 114 or by a gNB located on-ground or in a satellite.

It is understandable for a person skilled in the art that the depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. One of the (e/g)NodeBs may be a Home (e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

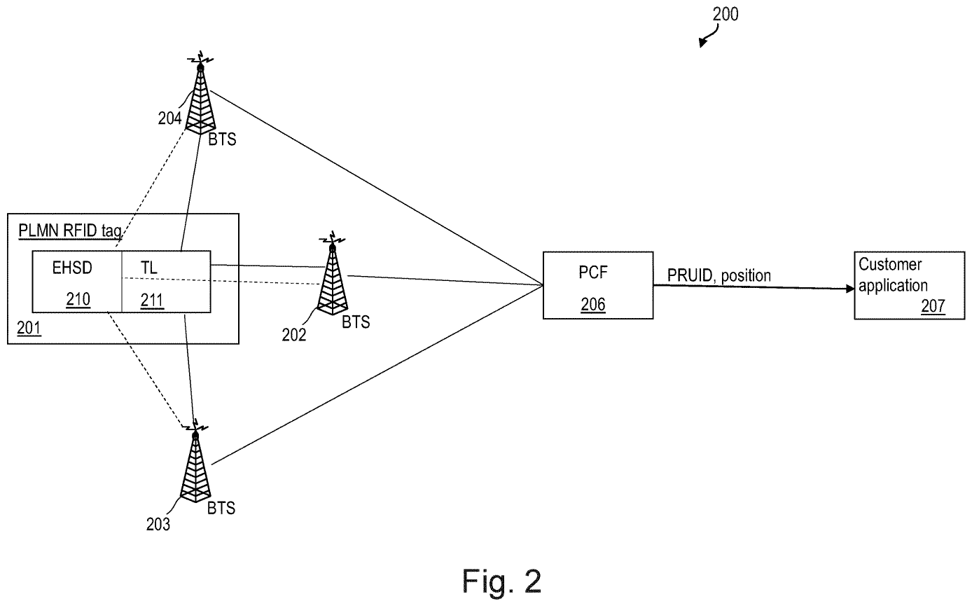

FIG. 2 is a schematic illustration of a wireless communication system 200. The communication system 200 may be configured to use a time division duplex (TDD) technique for data transmission.

For simplicity, communication system 200 is shown to include three terrestrial beacon systems (BTS) such as base stations 202, 203 and 204 and an apparatus 201 according to the present subject matter. The apparatus 201 may, for example, be a PLMN RFID tag. The apparatus 201 comprises and an energy harvesting and storage device (EHSD) 210 and a transmitting logic (TL) 211. Each base station of the base stations 202 through 204 may, for example, be eNodeB or gNB e.g., as described with reference to FIG. 1. That is, the communication system 200 may support a same RAT or different RATs. Each base station of the base stations 202 through 204 may serve UEs within a respective geographical coverage area of service or cell.

The communication system 200 may comprise a core network comprising a Policy Control Function (PCF) 206. The base stations 202 through 204 may be connected to the core network. For example, the base stations 202 through 204 may connect to the PCF 206.

In this particular example, RF waves may be received through an antenna of the apparatus 201. This may cause a potential difference across the length of the antenna. This potential difference may cause charge carriers to move along the length of the antenna. The energy from this movement may be converted by the energy harvesting and storage device 210 into a stable DC current which is then stored in the energy harvesting and storage device 210. The stored energy may be used to power electronic devices of the apparatus 201 such as the transmitting logic 211 in order to transmit (e.g., broadcast) an access request signal. This access request signal may be received or captured by the base stations 202 through 204. Each base station of the base stations 202 through 204 may determine a distance between its antenna and the apparatus 201 and send the determined distance to the PCF 206. The PCF 206 may use the determined distances to estimate a position of the apparatus 201. This position may be sent by the PCF to a consumer application 207 of a user device, such as a user of the apparatus 201.

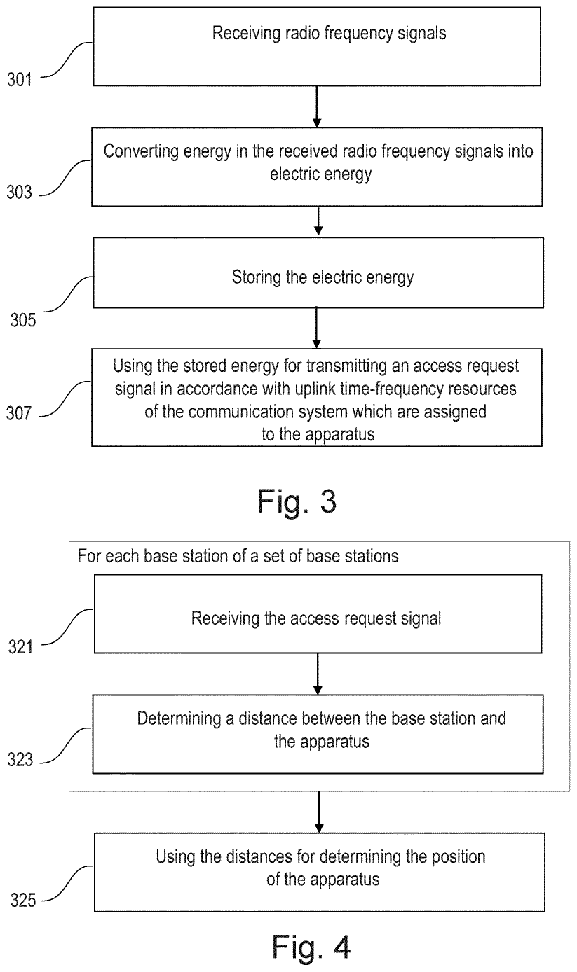

FIG. 3 is a flowchart of a method according to an example of the present subject matter. For the purpose of explanation, the method described in FIG. 3 may be implemented in the system illustrated in FIG. 2, but is not limited to this implementation. The method may, for example, be performed by the apparatus 201.

The method starts at step 301, where the apparatus 201 may receive radio frequency signals e.g., via an antenna of the apparatus 201. The energy in the received radio frequency signals may be converted in step 303 into electric energy (or electrical energy). The electric energy may be stored in step 305. The stored energy may be used in step 307 for transmitting an access request signal in accordance with uplink time-frequency resources of the communication system which are assigned to the apparatus 201. The access request signal may, for example, be broadcasted by the apparatus 201.

FIG. 4 is a flowchart of a method according to an example of the present subject matter. For the purpose of explanation, the method described in FIG. 4 may be implemented in the system illustrated in FIG. 2, but is not limited to this implementation.

Each base station of a set of three or more base stations such as the base stations 202 through 204 may receive in step 321 or capture an access request signal sent or broadcasted by an apparatus such as the RFID tag 201. A distance between the antenna of the base station and the apparatus 201 may be estimated by the base station in step 323 using the received access request signal. The determined distances by the set of base stations may be used in step 325 to estimate a position of the apparatus e.g., using triangulation technique. Step 325 may be performed by a system. The system may, for example, be one base station of the set of base stations or a separate system such as the PCF 206. The system may receive from the set of base stations the computed distances.

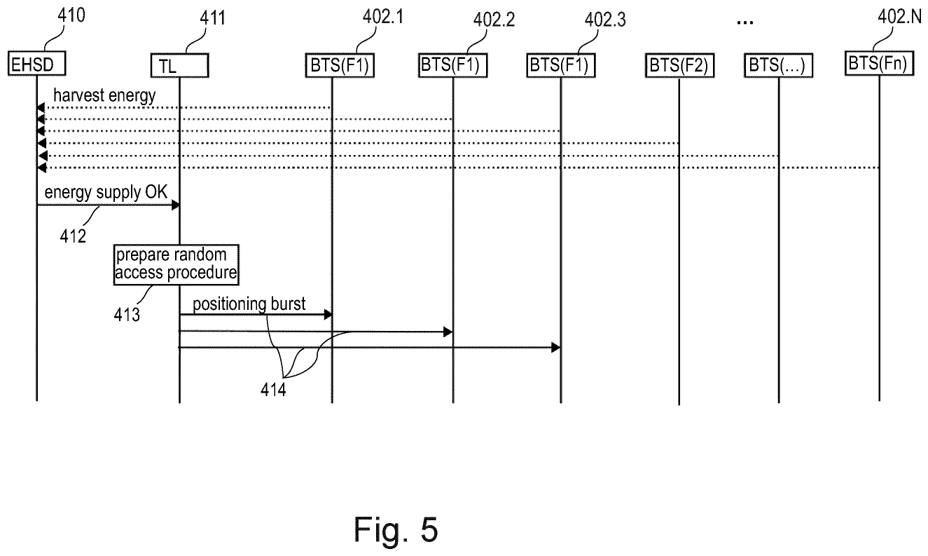

FIG. 5 illustrates an example of messages exchanged between an apparatus and base stations in accordance with an example of the present subject matter. The apparatus may, for example, be the apparatus described with reference to FIG. 2, wherein the apparatus comprises an energy harvesting and storage (EHSD) device 410 and a transmitting logic (TL) 411.

As indicated by dashed lines, the energy harvesting and storage device 410 may receive RF signals from the base stations 402.1 through 402.N. The RF signals may be received in frequency bands F1 through Fn which are supported by the base stations 402.1 through 402.N. The EHSD 410 may convert the energy in the received RF signals into electric energy and store said electric energy. The EHSD 410 may supply energy (412) to the TL 411. The TL 411 may prepare (413) a random access procedure in order to send or broadcast a position burst. A subset of base stations 402.1 through 402.3 may receive (414) the positioning burst. The subset of base stations may use the received positioning burst to determine the respective distances to the apparatus. These distances may be used to determine the position of the apparatus.

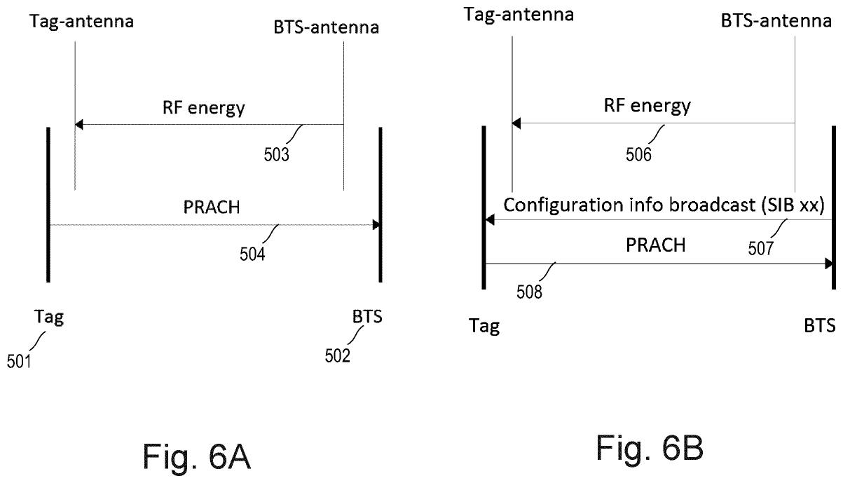

FIG. 6A is a diagram illustrating a method for sending a PRACH burst by an apparatus 501 to a base station 502 in accordance with an example of the present subject matter. The apparatus 501 may, for example, be a tag. The tag 501 may harvest (503) RF energy obtained through an antenna of the tag 501 e.g., from the base station 502. The tag 501 may only be active when it has harvested enough energy.

The harvested energy may be used to send (504) by the tag 501 the PRACH burst to at least the base station 502 using pre-configured time-frequency resources. FIG. 6A may thus provide a preconfigured solution.

The antenna of the tag 501 may be designed to harvest in one dedicated band only (frequency selective). This may be to ensure that the tag 501 transmits its PRACH only in areas, where this frequency band is used. In case the energy is harvested in multiple frequency bands, the tag 501 may transmit the PRACH burst only on the frequency where energy was harvested.

Base stations on multiple separated locations may be receiving and processing this PRACH burst. Based on the PRACH burst, an exact time of arrival may be calculated at each receiving base station, and sent to a central processing for triangulation in order to determine the position of the tag.

The tag 501 may send regularly PRACH bursts which are compatible to a standard (like 6G or 5G). Burst frequency may be defined by energy level harvested or other timers. Assuming, for example, that the burst duration is smaller than or equal to 500 μs, the bandwidth is 200 khz and the output power is 250 mW/20 MHz, the transmission of the burst may require: 200 KHz/20 MHz*250 mW*500 μs*100/25=5 μWs assuming 25% energy efficiency of the system. On the other hand, the energy collection rate may depend on the distance to the BTS antenna. Assuming for example that the energy collection rate is 7.5 μW, harvesting 5 μWs may take 5 μWs/7.5 μW=0.7 s. This may indicate that the PRACH burst may be sent frequently enough for positioning purposes.

FIG. 6B provides a network configured solution. For that, the tag 501 may harvest (506) RF energy obtained through an antenna of the tag 501 e.g., from the base station 502. The tag 501 may only be active when it has harvested enough energy. The tag 501 may receive (507) configuration information in a signal broadcasted by the base station 502. The broadcasted signal may, for example, be a PRS. The configuration information may, for example, indicate the time-frequency resources that can be used by the tag 501 to send (508) the PRACH burst.

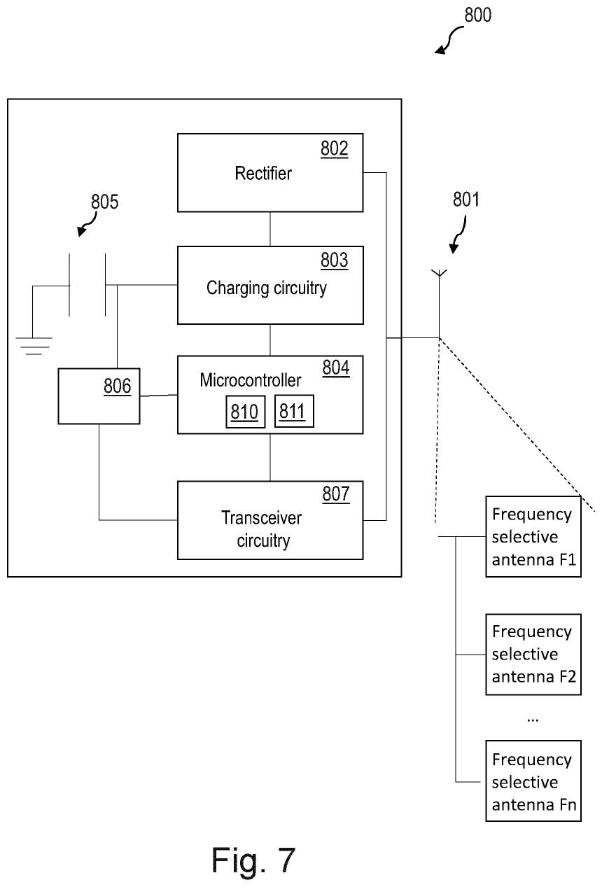

FIG. 7, is a block diagram of an apparatus 800 according to the present subject matter. It is to be noted that the apparatus 800 shown in FIG. 7 may comprise several further elements or functions besides those described herein below, which are omitted herein for the sake of simplicity as they are not essential for the understanding.

The apparatus 800 includes one or more antennas, represented by the antenna 801, which may be used to transmit and receive communications for the apparatus 800, as well as capture RF emissions to be stored as energy. The design of the antenna 801 may be affected by the RF band(s) at which the apparatus 800 may communicate and the RF band(s) at which the apparatus 800 may capture RF emissions. For example, as indicated in FIG. 7, the antenna 801 may include an antenna per band of the list of frequency bands F1 to Fn.

The antenna 801 may be connected a transceiver circuitry 807 and a rectifier 802. The connection may, for example, enable a simultaneous RF harvesting and data communication. Alternatively, the antenna 801 may be connected to either the rectifier 802 or transceiver circuitry 807 e.g., via switch. The transceiver circuitry 807 may be used for communicating data to and from the apparatus 800. The rectifier 802 may, for example, be an RF/microwave rectifier that converts the energy from the captured RF emissions as input to a DC electrical energy output. The rectifier 802 may be implemented using, for example, diodes. A charging circuitry 803 may adjust the voltage or other components of the DC output from the rectifier 802 to a form suitable for storing in an energy storage device 805. The energy storage device 805 may comprise a battery, capacitor (e.g., capacitor with 10 μWs@5V=400 nF), supercapacitor, and/or other electrical energy storage device. The energy storage device 805 may be the only source of power for the apparatus. The components of the apparatus 800 may receive electrical power from the energy storage device 805. For example, a Zener diode may be used to measure if the capacitor is sufficiently charged.

The apparatus 800 further comprises a microcontroller 804 which may be configured for managing the operation and data communications of the apparatus 800. The microcontroller 804 may manage the transceiver circuitry 807 for wireless transmission and reception of data by the apparatus 800. The transceiver circuitry 807 may, for example, comprise a radio transmitter. The radio transmitter may be configured to supply an oscillating radio frequency electric current to the antenna, and the antenna may radiate the energy from the current as electromagnetic waves (e.g., radio waves).

The microcontroller 804 may monitor charging of the energy storage device 805 via the charging circuitry 803.

The electrical power from the energy storage device 805 may be adjusted by a voltage regulator 806 in order to accommodate the electrical needs of disparate electrical components. For example, the voltage regulator 806 may adjust the 3.0 V output from the energy storage device to the 3.45 V required by the microcontroller 804.

The microcontroller 804 may comprise a processing function or processor 110, such as a central processing unit (CPU) or the like, which executes instructions given by programs or the like related to a flow control mechanism. The processor 110 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. The microcontroller 804 may comprise a memory 811. The memory 811 may be usable, for example, for storing data and programs to be executed by the processor 110 and/or as a working storage of the processor 110.

The processor 110 is configured to execute processing related to the above described subject matter. In particular, the apparatus 110 may be configured to perform the method as described in connection with FIG. 2.

For example, the processor 110 is configured for: receiving via the antenna radio frequency signals; converting via the rectifier energy in the received radio frequency signals into electric energy; storing the electric energy; using the stored energy for transmitting via the transceiver circuitry an access request signal in accordance with uplink time-frequency resources of the communication system which are assigned to the apparatus.

As will be appreciated by one skilled in the art, aspects of the present invention may be embodied as an apparatus, method, computer program or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer executable code embodied thereon. A computer program comprises the computer executable code or “program instructions”.

Any combination of one or more computer readable medium(s) may be utilized. The computer readable medium may be a computer readable storage medium. A ‘computer-readable storage medium’ as used herein encompasses any tangible storage medium which may store instructions which are executable by a processor of a computing device. The computer-readable storage medium may be referred to as a computer-readable non-transitory storage medium. The computer-readable storage medium may also be referred to as a tangible computer readable medium. In some embodiments, a computer-readable storage medium may also be able to store data which is able to be accessed by the processor of the computing device.

‘Computer memory’ or ‘memory’ is an example of a computer-readable storage medium. Computer memory is any memory which is directly accessible to a processor. ‘Computer storage’ or ‘storage’ is a further example of a computer-readable storage medium. Computer storage is any non-volatile computer-readable storage medium. In some embodiments computer storage may also be computer memory or vice versa.

A ‘processor’ as used herein encompasses an electronic component which is able to execute a program or machine executable instruction or computer executable code. References to the computing device comprising “a processor” should be interpreted as possibly containing more than one processor or processing core. The processor may for instance be a multi-core processor. A processor may also refer to a collection of processors within a single computer system or distributed amongst multiple computer systems. The term computing device should also be interpreted to possibly refer to a collection or network of computing devices each comprising a processor or processors. The computer executable code may be executed by multiple processors that may be within the same computing device or which may even be distributed across multiple computing devices.

Computer executable code may comprise machine executable instructions or a program which causes a processor to perform an aspect of the present invention. Computer executable code for carrying out operations for aspects of the present invention may be written in any combination of one or more programming languages, including an object oriented programming language such as Java, Smalltalk, C++ or the like and conventional procedural programming languages, such as the “C” programming language or similar programming languages and compiled into machine executable instructions. In some instances the computer executable code may be in the form of a high level language or in a pre-compiled form and be used in conjunction with an interpreter which generates the machine executable instructions on the fly.

Generally, the program instructions can be executed on one processor or on several processors. In the case of multiple processors, they can be distributed over several different entities. Each processor could execute a portion of the instructions intended for that entity. Thus, when referring to a system or process involving multiple entities, the computer program or program instructions are understood to be adapted to be executed by a processor associated or related to the respective entity.

1-15. (canceled)

16. A method, comprising:
receiving at an apparatus radio frequency signals with an antenna of the apparatus;
converting energy in the received radio frequency signals into electric energy;
storing the electric energy in an energy storage device; and
using the stored energy for transmitting an access request signal in accordance with uplink time-frequency resources of a communication system which are assigned to the apparatus.

17. The method of claim 16, further comprising:
receiving the access request signal with one or more nodes of the communication system; and
using the access request signal with the one or more nodes for determining a position of the apparatus.

18. The method of claim 16, the access request signal being a random access signal on a physical random access channel.

19. The method of claim 16, further comprising: using the stored energy to receive a configuration signal from a node of the communication system, and decoding the configuration signal for determining the uplink time-frequency resources.

20. The method of claim 16, the antenna being configured for receiving the radio frequency signals utilizing a parity-time symmetry.

21. A non-transitory program storage device readable with an apparatus, tangibly embodying a program of instructions executable with the apparatus for performing operations, the operations comprising:
causing an apparatus to receive radio frequency signals;
converting energy in the received radio frequency signals into electric energy;
storing the electric energy; and
using the stored energy for transmitting an access request signal in accordance with uplink time-frequency resources of a communication system which are assigned to the apparatus.

22-26. (canceled)

27. An apparatus for a communication system, the apparatus comprising:
at least one processor; and
at least one memory storing instructions that, when executed with the at least one processor, cause the apparatus to perform:
receiving radio frequency signals;
converting energy in the received radio frequency signals into electric energy;
storing the electric energy; and
using the stored energy for transmitting an access request signal in accordance with uplink time-frequency resources of the communication system which are assigned to the apparatus.

28. The apparatus of claim 27, wherein the instructions, when executed with the at least one processor, cause the apparatus to receive the radio frequency signals in one or more frequency bands, wherein the access request signal is transmitted in a selected frequency band of the one or more frequency bands.

29. The apparatus of claim 27, wherein the instructions, when executed with the at least one processor, cause the apparatus to repeatedly transmit the access request signal in accordance with a transmission frequency.

30. The apparatus of claim 29, wherein the instructions, when executed with the at least one processor, cause the apparatus to estimate the transmission frequency using a rate of collection of energy with the apparatus.

31. The apparatus of claim 29, wherein the transmission frequency is a pre-configured parameter that is received from a node of the communication system.

32. The apparatus of claim 27, wherein the instructions, when executed with the at least one processor, cause the apparatus to transmit the access request signal according to a radio resource control protocol.

33. The apparatus of claim 27, wherein the access request signal is a random access signal on a physical random access channel.

34. The apparatus of claim 27, wherein the access request signal comprises information that is configured to trigger a determination of the position of the apparatus based on the access request signal.

35. The apparatus of claim 27, wherein the access request signal comprises a unique identifier of the apparatus.

36. The apparatus of claim 27, wherein the uplink time-frequency resources are preconfigured resources.

37. The apparatus of claim 27, wherein the instructions, when executed with the at least one processor, cause the apparatus to use the stored energy to receive and decode a configuration signal from a node of the communication system, the configuration signal indicating the uplink time-frequency resources.

38. The apparatus of claim 27, wherein the instructions, when executed with the at least one processor, cause the apparatus to use the stored energy in response to determining that the stored energy is higher than the energy required to perform the transmission of the access request signal.

39. The apparatus of claim 27, wherein the instructions, when executed with the at least one processor, cause the apparatus to use the stored energy to sense one or more physical characteristics of an environment of the apparatus, wherein the access request signal comprises the sensed values.

40. The apparatus of claim 27, being comprised in a mobile device, wherein the instructions, when executed with the at least one processor, cause the apparatus to transmit the access request signal in case the mobile device is switched off or out of battery.
